(19) United States
(12) Patent Application Publication
(10) Pub. No.: US 2024/0253055 A1
(43) Pub. Date: Aug. 1, 2024

(54) Integrated Magnetic Bead Assay Processing Method and Apparatus

(71) Applicant: Applied Biocode Inc., Santa Fe Springs, CA (US)

(72) Inventors: Winston Z. Ho, Hacienda Heights, CA (US); Dennis Chou, Santa Fe Springs, CA (US); Carlos Aldana, Santa Fe Springs, CA (US); Marc Macon, Santa Fe Springs, CA (US)

(21) Appl. No.: 18/103,985

(22) Filed: Jan. 31, 2023

(51) Int. Cl. B03C 1/06

(52) U.S. Cl. CPC B03C 1/06; B03C 2201/20

(57) ABSTRACT

An integrated magnetic microbead processing apparatus includes a microplate having magnetic microbeads in microwells. A bottom of the microplate includes cavities between the microwells. A heating/cooling plate supports a base of the microplate and has a plurality of holes. A vertically movable magnet support plate includes a plurality of magnetic pins, each of which can protrude through one hole in the plurality of holes of the heating plate and into the cavity of the microplate. The magnetic pins are height adjustable. A shaker is operably connected to the microplate and is configured to shake the microplate, the heating/cooling plate, the magnetic support plate.

### BACKGROUND

### Field of the Invention

The invention relates generally to assay beads and methods for use thereof to carry out protein, nucleic acid and other specific binding bioassays with magnetic beads, and more particularly relates to an integrated compact multi-function bioassay processing apparatus for magnetic beads that includes washing, separation, mixing, and reaction incubation with minimum bead loss.

### Description of Related Art

Magnetic microbeads in bioprocessing are generally paramagnetic, that is, the microbeads have a magnetic property when placed within a magnetic field but retain no residual magnetism when removed from the magnetic field. This paramagnetic property allows magnetic collection of the microbeads and resuspension of the microbeads when the magnetic field is removed. Collection and resuspension of the magnetic microbeads can be repeated easily and rapidly any number of times. As a result, magnetic microbeads are used widely in bioprocessing for target enrichment or target capture. In the case of protein assays, such as sandwiched immunoassays, the unbound or non-specific antibodies or antigens can be removed after the magnetic microbead-antibody-antigen reaction. The secondary antibody is coupled on the antibody and antigen complex, then a fluorescence or a chemiluminescence labeling agent is used for optical detection. Magnetic microbeads enable washing of unbound molecules from the microbeads, adding buffer solution, or removing any contaminant in the solution. In the case of nucleic acid specific binding assays such as DNA or RNA assays, the unbound or non-specific nucleotides can be removed after hybridization. Thus, a series of biochemical reactions and extensive washing are usually required in the magnetic microbead bioprocesses. The processes are commonly performed on a 96-well, 384-well or 1536-well microplate with an automated robotic system and gripper for high throughput assays.

For about the past 20 years, barcoded magnetic microbeads or digital magnetic microbeads have been developed and used for multiplex or syndromic bioassays. Multiplex assays not only extend from one test per sample to many tests per sample, offering comprehensive testing results; but also allow a panel of tests performed with minimum sample volume. Each micrometer size magnetic microbead, either color coded or digitally coded, can be immobilized with a specific protein or molecular probe to capture a specific desired target in the sample. The probe-target complex is then tagged with labelled agent, such as fluorophore, for optical detection. Thus, the barcoded magnetic microbeads are used for target identification and the fluorescence detections. Barcode magnetic microbeads offer many advantages, but they are more expensive than the non-barcoded magnetic microbeads. For multiplex assays, it is extremely important to have a sufficient and consistent number of magnetic microbeads with specific barcodes in every microwell for every assay and every sample. For example, for 20 plex assays, each of the 96 microwells is required to have magnetic microbeads with 20 barcodes and each barcode needs to have a minimum number of microbeads, such as 20-30 microbeads or 200-300 microbeads to ensure the data accuracy.

There are magnetic microbead-based washers on the market. For example, the ELx405™ Magnetic Bead Washer by BioTek offers full microplate plate washing of magnetic microspheres. The microplate is located on a magnetic plate with an array of magnetic blocks. Thus each microwell is on top of the magnetic block. Peristaltic and syringe pump dispenser modules with autoclavable fluid paths for automating wash/dispense/aspirating steps on a single platform.

Microplate shaking and heating devices are currently in the market. For example, a microplate shaker by Thermo Scientific can either shake or heat or shake/heat microplates. It provides shaking oscillation 250-1.200 rpm/2 mm amplitude. The heat is transferred to the sample from the platform and the heated lid. The temperature can be regulated from 25° C. or RT up to 60° C. Mixing and heating and cooling modes can be used both simultaneously and independently, i.e. the device can work as a shaker and as a thermostat.

U.S. Pat. No. 5,779,907 issued on Jul. 14, 1998, entire contents of which are incorporated herein by reference, discloses an apparatus using a 96-well microplate and includes a mechanism for supporting the microplate in a relatively fixed position. A magnetic microplate assembly containing multiple cylindrical magnets is positioned in 4×6 arrays for insertion from the bottom of the microplate in the spaces between the wells of the microplate. A device for moving the magnet microplate assembly relative to the microplate permits selective separation of magnetic components within the microplate wells. The magnets, preferably cylindrical in configuration, are placed between groups of four wells in the microplate. The apparatus is for manual use and the height of the magnet is fixed.

U.S. Pat. No. 6,645,431 issued on Nov. 11, 2003, entire contents of which are incorporated herein by reference, discloses an apparatus for automated magnetic separation of materials in laboratory trays including a frame upon an upper surface of which a multiwell laboratory tray may be placed A base plate is mounted a plurality of upstanding magnets disposed below the upper surface and a flexible bladder is used to raise the base plate to insert the upstanding magnets into interwell spaces in said laboratory tray.

U.S. Pat. No. 8,512,558 issued on Aug. 20, 2013, discloses a magnetic separation system for use in methods employing magnetic particles The system includes a magnetic separation plate having a support plate and magnetic pins in a predetermined geometrical arrangement The magnetic pins have a fastening portion, an intermediate portion and a separation portion and are fastened to the support plate at their fastening portion via a holder containing one or more flexible elements or o-rings The magnetic pins are individually laterally displaceable at their separation portion.

### SUMMARY OF THE INVENTION

When processing bioassays with two independent magnetic washer and heating/cooling/shaking devices, problems are encountered. For example, as soon as the plate is moved out of the heating/cooling/shaking device, the magnetic microbeads will no longer stay in suspension and will sink down and randomly stick to the bottom of the microwell by static force. Moreover, once the magnetic microbeads are randomly distributed and adhered to the surface, some of the magnetic microbeads are farther away from the tip of the magnetic pin (˜ 6.8 mm microwell diameter) than others, which can cause low and unequal paramagnetic force, thus resulting in high microbead loss and inconsistency.

An integrated magnetic microbead processing apparatus, as described herein includes a microplate having magnetic microbeads in microwells. A bottom of the microplate includes cavities between the microwells. A heating/cooling plate supports a base of the microplate and has a plurality of holes. A vertically movable magnet support plate includes a plurality of magnetic pins, each of which can protrude through one hole in the plurality of holes of the heating plate and into the cavity of the microplate. The magnetic pins are height adjustable. A shaker is operably connected to the microplate and is configured to shake the microplate, the heating/cooling plate, the magnetic support plate.

In one embodiment, the shaker may have an adjustable orbital rotation speed of between 0 and 1200 rpm. The orbital rotation provides mixing for the reaction, and also provides a circular force to move the magnetic microbeads to the sides of the microwells and closer to the magnet pins for high efficiency bead attraction.

In another embodiment, the height of the magnetic pins protruding above said heating plate is adjustable according to the liquid levels in the microwells.

In another embodiment, the height of the magnetic pins protruding above said heating plate is adjustable between 1.5 mm to 4 mm.

In another embodiment, the heating/cooling plate is configured to provide a temperature from 25° C. or RT up to 60° C.

In another embodiment, the shaker has a home flag that ensures said orbital rotation stop at the same designated location.

In another embodiment, an integrated magnetic microbead processing method includes providing a microplate having magnetic microbeads in the microwells, the bottom of the microplate having cavities between said microwells, a heating/cooling plate, which supports the microplate, the heating/cooling plate having a plurality of holes, a vertically movable magnet support plate containing a plurality of magnetic pins, each of which can protrude through a hole in the plurality of holes and into the cavity of the microplate, the plurality of magnetic pins being height adjustable, and a shaker configured to shake the microplate, the heating/cooling plate, and the magnetic support plate, to enhance the magnetic microbeads separation. Activating the shaker with proper orbital rotation, and then raising the magnetic pins to increases the microbead capture efficiency.

In another embodiment, the method includes the shaker having an adjustable orbital rotation speed between 0-1200 rpm.

In another embodiment, the method further includes the step of rotating the magnetic microbeads while the magnetic pins are down, and attracting the magnetic microbeads towards the sides of the microwells while said magnetic pins are up.

In another embodiment, a microplate plastic cover and heated lip assembly are provided to enhance homogeneous temperature distribution and automation with liquid handling robotic system.

In another embodiment, the microplate has flat and optically transparent bottom.

In another embodiment, the magnetic microbeads comprise at least some barcoded magnetic microbeads.

In another embodiment, a heated lid and loaded pogo pins help keep the microplastic lid from sticking to the heated lid.

In another embodiment, to increase the efficiency of the magnetic microbeads capture by the magnets, a gentle shaking speed of <500 RPM for a short period of time (<30 seconds), can very efficiently move the magnetic microbeads to near the magnet for high yield of magnetic microbead capture.

Unless stated otherwise, in other undescribed embodiments, any feature described in the above summary, or in the detailed description below, may be combined with any other feature or features of the integrated magnetic microbead processing apparatus or method.

### BRIEF DESCRIPTION OF THE DRAWINGS

In the following drawings, like reference numerals designate like or similar parts throughout the drawings.

FIG. 1 illustrates a perspective view of magnetic microbead loss in a prior art magnetic bead processing system with an external magnet block on the bottom of the microplate that is common in prior art magnetic bead processing systems having a base mounted magnet.

FIG. 2 illustrates a perspective view of magnetic microbead loss in prior art magnetic bead processing systems with an external cylindrical magnetic pin on the side of a microwell or in a cavity between the microwells.

FIG. 3a illustrates a perspective view of one embodiment of the present invention with the magnetic microbeads suspended in orbital rotation while magnetic pins are down

FIG. 3b illustrates a perspective view of the embodiment of FIG. 3a, with the magnetic pins raised, with proper adjustable height and shaking speed, to attract magnetic microbeads towards the magnetic pin, and thus towards the sides of the microwells when the microbeads are rotated.

FIG. 4 illustrates a perspective view of the apparatus of the present invention with a heating/cooling plate, retractable and adjustable multiple magnetic pins, and a shaking mechanism.

FIG. 5 is a perspective view of the integrated apparatus with adjustable multiple magnetic pins in a down position.

FIG. 6. is a perspective view of the orbital shaking elements with adjustable shaking speed of the apparatus.

FIG. 7. is a perspective view of a heated lid assembly.

### DETAILED DESCRIPTION

The magnetic microbead bioassay process can be lengthy including more than 10 steps of operation. The process includes probe-target reaction, many washing, secondary antibody reaction, many washing, fluorescence labeling reaction, and many washing processes; and transfer the plates back and forth between heater/cooler/shaker and magnetic washer. The heater/cooler/shaker is used as an incubator for antigen-antibody immunoassay, sandwiched assay chemistries, nucleic acid hybridization for molecular assays, and labeling chemistry. All reactions require temperature control and mixing the magnetic microbeads. To mix magnetic microbeads, a shaking mechanism is implemented. After every reaction, the plates are transfer to magnetic microbeads washer. Magnetic bead washers, use external magnets either at bottom or at the side of the microwell, to separate the magnetic microbeads from the liquid and avoid the magnetic microbeads been vacuum out of the well during liquid aspiration. The purpose of washing is to keep the reactions on magnetic microbeads, and wash out all the unbounded chemicals, such as free fluorophores, contaminants, sample matrix materials, or residual buffer solution out of the well.

The embodiments described herein advantageously integrate magnetic microbead washing with shaking and heating/cooling into a single device; while simultaneously providing a highly efficient magnetic microbead processes with minimum microbead loss. The conventional heating/cooling/shaker device and the magnetic microbead washer/shaker are independent devices. Each device is facilitated with shaking mechanisms. After the chemical reactions in the heating/cooling/shaker device, the microplate needs to be transferred to the magnetic shaker either manually or by robotic system.

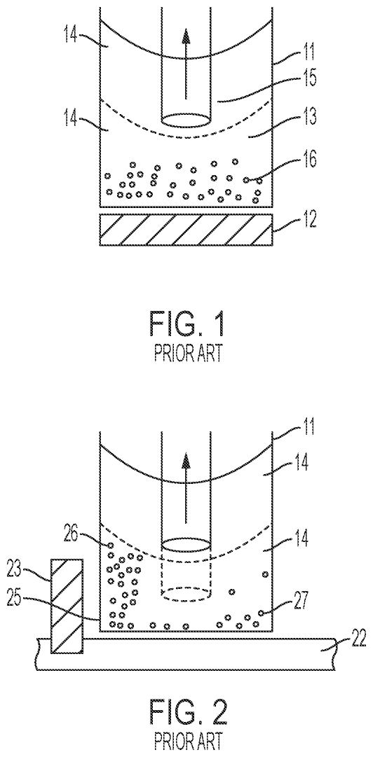

Two prior art magnetic microbead washer configurations are known in the art. A first configuration has an external magnet block on the bottom of the microplate, such as shown in FIG. 1 (prior art). As soon as the microplate 11 is put on the magnet block 12 of the washer, the microbeads 16 will be immediately attracted to the bottom of the microwell 13. The meniscus liquid level 14 will drop when the pipette tip 15 is lower down to vacuum out the liquid. A challenge is to aspirate as much liquid as possible, while keeping as many magnetic microbeads in the well as possible. From the illustration, it can be seen that the pipette tip can vacuum out the microbeads easily. A second configuration has an external magnetic pin or rod on the side of the microwell, as shown in FIG. 2 (prior art). The magnetic pins 23 are fixed on a base plate 22. When the microplate 11 is put on the magnet base 22, the microbeads will be attracted to the side of the microwell 13 as shown. In the second configuration, the height of the magnetic pin 23 is very critical. The tip of the magnetic pin has the strongest magnetic force. Depending on the liquid level in the microwell, either too high or too low, microbead attraction efficiency will vary. The height of the magnetic pins is not adjustable. Additionally, the position of the magnetic pin is very sensitive. The distance 25 tolerances of pin position and preadapted cavities frequently lead to non-uniform paramagnetic field distribution 26 among the four neighboring wells. Finally, as soon as the microplate is moved away from the heating/shaking device, magnetic microbeads 16 will start to fall towards the bottom of the microwell and randomly distribute on the bottom by gravity. Once the microbeads are settled on the bottom surface, the distance of each surface magnetic microbeads 27 and the tip of the magnetic pin will vary significantly, for example when the microwell diameter is ˜6.8 mm. As a result, the magnetic force will vary significantly also. In addition, the weak electrostatic force makes the magnetic microbeads stick on the bottom surface, which causes problems attracting the far away microbeads to the magnetic pin. All these factors will cause inconsistent and low bead attraction efficiency.

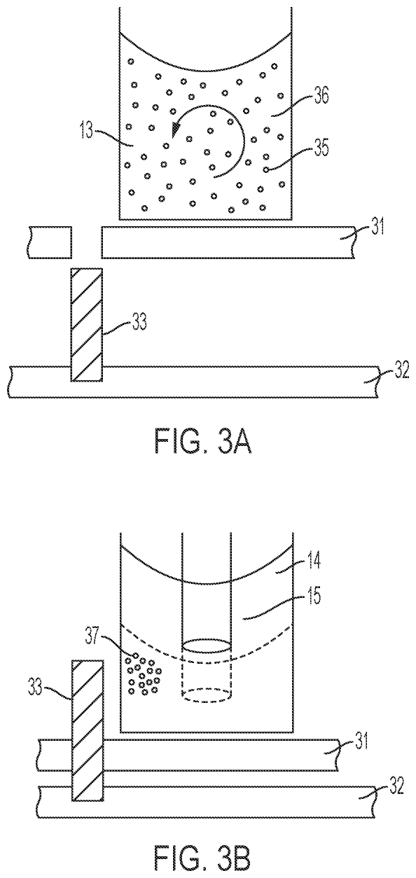

FIG. 3(a) illustrates one embodiment of a microwell 13 according to the disclosure, which is located on top of a heating/cooling plate 31 with rotating microbeads 36 in the microwell 13 before engaging the magnetic pin 33. The purpose of this continuous orbital rotation 35 is to homogeneously distribute the microbeads 36 in the liquid and move the magnetic microbeads 36 into and out of the vicinity of the magnetic pin 33. As a result, all the microbeads 36 have an opportunity to be attracted to the magnetic pin 33 once the magnetic pin 33 is raised up. The shaker with an orbital motion (not shown in FIG. 3a) causes a circular or orbital motion of the microbeads 36, thus creating a more uniform distribution of the microbeads 36 within the microwell 13. Other shaking mechanisms, such as vibrations by oscillating, reciprocating, or periodic, are not able to move the microbeads 36 in a circular motion in the microwell 13.

While the microbeads 36 are circulating in the microwell 13, the external magnetic pin 33 on the magnet base plate 32 is raised up relative to the heating/cooling plate 31, to protrude through the heating/cooling plate 13 as shown in FIG. 3(b). The orbital rotation force, depending on the rotational speed, may be controlled to be less than the magnetic force; otherwise, it will spin the microbeads 36 out of the magnetic field. Multiple slow rotational speeds, such as, for example, 500 rpm, then 300 rpm can be used to gently circulate the microbeads 36 freely within the microwell 13, then allowing the microbeads 36 to be captured by the magnetic field of the magnetic pin 33 after the magnetic pin 33 is raised up. With 10-30 seconds of the continuous pre-shaking or rotation, most of the microbeads 36 will be attracted to the magnetic pin 33.

Tables 1 and 2 show the microbead 36 loss percentages of a 96-well plate with between 1,000-2,000 magnetic microbeads 16, after six washes cycles. As illustrated in Table 1, without pre-shaking, the microbead 36 losses are high, and very non-uniform across the whole plate. Although the average loss is approximately 32%, the loss can be very non-uniform. Some wells have losses as high as 70%-80% and show significant variation (see Table 1). High bead loss is a major problem. While with 500 rpm pre-shaking for 30 seconds with the magnetic pin down and no magnetic field, the microbead 36 losses are significantly lower, with an average of approximately 12%, and relatively uniform across the whole plate (see Table 2). The maximum loss across all 96 wells of 25% loss after 6 washes is an excellent result, and unexpected magnitude of improvement over prior art shakers and washers.

The height of the magnetic pin 33 may be adjusted depending on the liquid level in the microwell 13 and the position of the pipette tip 15. By properly adjusting the magnetic pin 33 height, the pipette tip 15 can be lower down to be near the bottom of the microwell 13 to aspirate a higher percentage of the liquid, because the microbeads 36 are moved laterally to the sides of the microwell 13, which causes microbead 36 loss to be reduced significantly (see Table 3). The pipette tip 15 provides a vacuum force to aspirate the liquid from the microwell 13 without lowering below a surface of the liquid to avoid the contamination of the microbeads 36. The microbead washing systems described herein advantageously suspend the magnetic microbeads 36 in orbital rotation by shaking and allow the magnetic pins 33 to raise with adjustable height to draw the magnetic microbeads 36 to the wall of the microwell 13 and away from the center of the microwell 13, where the pipette tip 15 will be located.

TABLE 1
Bead loss percentage without shaking

| | 1 | 2 | 3 | 4 | 5 | 6 | 7 | 8 | 9 | 10 | 11 | 12 |
|---|---|---|---|---|---|---|---|---|---|---|---|---|
| A | 57.1 | 11.6 | 76.4 | 21.9 | 53.8 | 10.3 | 72.0 | 14.3 | 43.0 | 5.1 | 47.0 | 5.5 |
| B | 41.8 | 7.9 | 40.1 | 0.2 | 42.1 | 7.8 | 42.8 | 7.3 | 11.3 | 1.4 | 19.8 | 2.6 |
| C | 79.8 | 28.9 | 73.2 | 11.3 | 69.5 | 18.0 | 59.9 | 14.3 | 61.8 | 17.3 | 57.8 | 13.2 |
| D | 76.9 | 18.2 | 69.1 | 9.5 | 50.4 | 17.0 | 35.7 | 0.4 | 40.8 | 3.7 | 30.7 | 0.6 |
| E | 80.0 | 34.5 | 66.4 | 24.5 | 54.2 | 10.5 | 47.8 | 30.9 | 47.3 | 24.9 | 65.1 | 9.2 |
| F | 59.0 | 12.8 | 53.7 | 2.8 | 37.8 | 2.6 | 34.4 | 14.7 | 26.8 | 2.3 | 32.3 | 0.1 |
| G | 88.9 | 43.5 | 55.1 | 29.3 | 60.1 | 18.6 | 61.4 | 24.9 | 55.5 | 23.8 | 40.8 | 14.2 |
| H | 47.7 | 9.1 | 44.4 | 6.4 | 49.7 | 7.6 | 34.9 | 9.6 | 25.3 | 8.2 | 14.8 | 6.9 |

TABLE 2
Bead loss percentage with shaking

| | 1 | 2 | 3 | 4 | 5 | 6 | 7 | 8 | 9 | 10 | 11 | 12 |
|---|---|---|---|---|---|---|---|---|---|---|---|---|
| A | 10.7 | 2.2 | 23.0 | 6.2 | 11.1 | 9.2 | 11.5 | 5.9 | 16.5 | 14.7 | 17.4 | 7.3 |
| B | 5.5 | 11.5 | 18.0 | 6.4 | 10.5 | 20.3 | 6.2 | 10.8 | 6.6 | 13.8 | 10.8 | 10.6 |
| C | 10.8 | 7.9 | 11.6 | 6.3 | 15.8 | 9.3 | 15.3 | 10.3 | 18.7 | 11.2 | 15.4 | 18.3 |
| D | 4.5 | 5.5 | 8.8 | 7.6 | 12.0 | 7.3 | 10.3 | 12.4 | 10.3 | 6.8 | 11.9 | 6.9 |
| E | 8.7 | 17.2 | 4.8 | 10.2 | 10.7 | 16.6 | 12.0 | 19.7 | 12.1 | 21.3 | 20.3 | 21.1 |
| F | 0.8 | 12.6 | 5.1 | 7.0 | 2.9 | 14.4 | 10.4 | 16.1 | 8.6 | 20.9 | 10.8 | 8.3 |
| G | 10.7 | 10.6 | 8.6 | 8.4 | 21.9 | 11.9 | 19.9 | 15.1 | 12.3 | 23.0 | 25.0 | 16.5 |
| H | 13.9 | 15.3 | 9.1 | 16.8 | 8.9 | 13.0 | 13.4 | 8.1 | 8.7 | 6.6 | 14.8 | 3.3 |

TABLE 3
Bead loss versus the height of the magnetic pin

| Magnetic Pin Height (mm - | Bead loss % |
|---|---|
| above the bottom of the well) | (average all wells) |
| 4.00 mm | 13.42% |
| 3.00 mm | 10.55% |
| 2.50 mm | 11.25% |
| 2.00 mm | 8.41% |
| 1.50 mm | 11.82% |

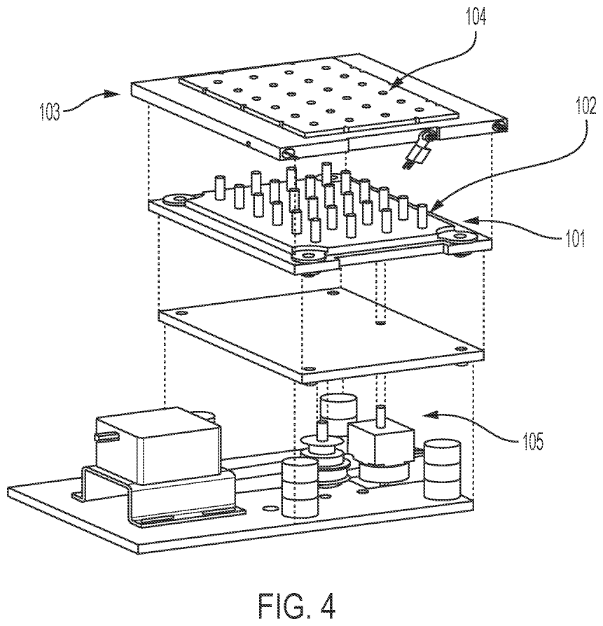

FIG. 4 illustrates one embodiment of a highly efficient and integrated magnetic microbeads assay processing apparatus according to the disclosure. FIG. 4 illustrates a perspective view of the apparatus including a heating/cooling plate 103, which is a supporting base of microplate that holds the microwells 13 of FIGS. 3a and 3b. The heating/cooling plate 103 has a plurality of holes 104, for receiving the magnetic pins 33 of FIGS. 3a and 3b. A vertically movable magnet support plate 101 includes the plurality of magnetic pins 102, which can protrude through the plurality of holes 104 of the heating/cooling plate 103 and into the cavity of the microplate. The vertically movable magnet support plate 101 is adjustable in height so that the magnetic pins 102 are adjustable relative to the microwells 13 (FIGS. 3a and 3b). An orbital shaker 105 is used to shake the microplate, the heating/cooling plate 103, and the magnet support plate 101. The plurality of holes 104 on the heating/cooling plate 103 are located in accordance with the position of the magnetic pins 102. The magnetic support plate 101, which has no magnetic property itself, includes the plurality of magnetic cylindrical pins 102 mounted permanently on the magnetic support plate 101. Each magnetic pin 102 is a cylindrical rod with approximately 2 mm in diameter and 10 mm in length in one embodiment. Other diameters, shapes and lengths are possible in other embodiments. When the magnet pins 102 are in a fully raised position, a length of the exposed magnetic pins be >4.5 mm above the heating/cooling plate 103 in one embodiment. Other heights are possible in other embodiments. The up and down movement of the magnet support plate 101 is controlled by a stepper motor actuator. The microplate, the heating/cooling plate 103, and the magnet support plate 101 are disposed on the orbital shaker 105. The heating/cooling plate 103 provides a temperature from 0 to 60° C. with the accuracy of +/−1° C. for the whole microplate in one embodiment. In other embodiments, other temperatures are possible and could be selected by those of ordinary skill in the art.

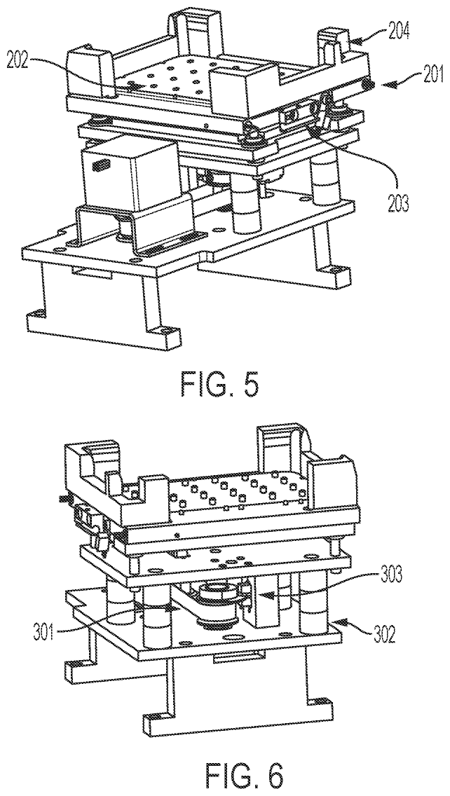

FIG. 5 is the perspective view of the integrated apparatus with the magnetic pins 102 in a down position. The heating/cooling plate 202 which is the support of the microplate, has multiple heating elements underneath the heating plate and has 24 holes for the magnetic pins 102 to move up and down through. The heating elements have dual cartridge heaters 201 which can quickly heat up the heating plate 202 with uniform heat distribution. The heater can control the microplate temperature between 30° ° C. to 60° C. in one embodiment. A thermal cutoff 203 that disconnects electrical power to the heater in the case of thermal overshoot. On the edge of the heating plate, two-piece Delrin nests 204 are used to secure the microplate, plastic lid (not shown), and heated lid (no shown), which are stacked on top of one another.

FIG. 6 is the perspective view of the integrated apparatus with the magnetic pins 102 in an up position. The system allows control of a shaking speed and a time duration for mixing magnetic microbeads. A motor drives an eccentric shaft 301 to turn the microplate in an orbital path of 0.08″ or 2 mm diameter from 0-1200 rpm in one embodiment. In other embodiments, other orbital paths are possible. A stack of flexible rubber standoffs 302 at four corners allows adequate freedom of movement for orbital rotation of the microplate. The speed of the orbital shaker's stage may be adjustable from 0-1200 rpm. The typical frequency is 800-1200 rpm for reactions and 300-800 rpm to move the magnetic beads to the vicinity of the magnetic pins for 10 to 30 seconds. The processor protocol provides ability for user to enter shaker rpms and time duration.

A home flag 303 advantageously ensures the orbital rotation stops at the same designated spot for reliable and precise locating. The orbital shaker stage returns to an exact home position so that pipette tips can align with each 96-well repeatedly. The exact location of the pipetting tip in the microwell will be the same for all 96 wells even after shaking. The exact location, in relative to magnetic pin and microwell, ensures the consistency of the liquid aspiration, thus avoid the bead number fluctuations.

The height of the magnetic pins is advantageously adjustable according to the relative position of the liquid level and pipette tip. Each magnetic pin in the magnet plate provides the same magnetic strength. In one embodiment, the magnetic strength is in the range of 0.65-0.9 lb., although other magnetic strengths are possible in other embodiments. It is known that the magnetic field distribution is strongest near the top of the pin. Thus, the magnetic microbeads will be drawn to near the top pin position on the well wall. If pin height is raised too low, microbeads will be sucked up when the aspiration tip is near the bottom of the well. In one embodiment, the optimum position is to rise the magnetic pin above the bottom of the well, such as >2 mm, but also not to exceed the height of the liquid solution such as <6 mm, otherwise catch no microbeads.

The shaker provides a moving mechanism to mix the magnetic microbeads in a homogeneous medium. The shaker not only can uniformly distribute the magnetic microbeads in the solution, but also can accelerate the reactions between the probes on the magnetic microbeads and the target molecule in the solution. The apparatus is an integrated and compact multi-function module, which can be incorporated into liquid handling robotic system.

All biochemistries require a series of reactions. A magnetic microbeads incubator is needed for probe and target, antigen-antibody, nucleic acid hybridization, and fluorescence label reactions under different (30-65 C) temperatures. The barcoded magnetic microbeads processing apparatus described herein is advantageously designed to be fitted into a robotic system. Three common problems of incubator are 1) difficulty in controlling the temperature across all 96 wells such as to avoid temperature gradients, 2) difficulty in avoiding liquid evaporation when the liquid is heated up, and 3) avoiding liquid condensation underneath any plastic cover or lid.

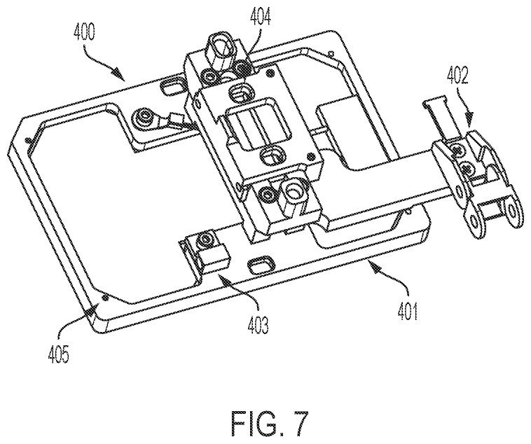

To solve these problems, the incubator described herein may also be facilitated with a microplate plastic cover (not shown), and a heated lid assembly (as shown in FIG. 7). The microplate plastic cover is used to avoid liquid evaporation, and the heated lid assembly which is seated on top of the microplate cover is used to avoid the temperature gradient. Both microplate cover and the heated lid assembly are picked up by a robot, moved from a parking dock and release the heated lid on top of the microplate cover. The heated lid assembly 400 includes a heating metal block 401, an electrical cable 402, a thermistor 403, and a latching mechanism 404 for robotic pick up. The heated lid provides temperature accuracy within +1.5° C. once the steady state set-point has been reached. The heated lid should have a thermal cutoff(s) to prevent thermal runaway. Heating plate and heated lid enclose the microplate, thus keep all 96 wells in the same temperature. All reactions can be incubated in a homogeneous environment. The heated lid includes a thermistor, and spring loaded “pogo pins”405 which help keep the microplate plastic cover from sticking to the heated lid. There are four pogo pins installed underneath the heated lid. The set-up is good for incorporating with a liquid handling robotic system.

Numerous modifications and variations in the practice of the invention are expected to occur to those skilled in the art upon consideration of the foregoing description on the presently preferred embodiments thereof. Consequently, the only limitations which should be placed upon the scope of the present invention are those that appear in the appended claims.

1. An integrated magnetic microbeads processing apparatus comprising:
a microplate having a plurality of magnetic microbeads in a plurality of microwells, a bottom of the microplate having a plurality of cavities between the microwells;
a heating/cooling plate supporting of the microplate, the heating/cooling plate having a plurality of holes;
a vertically movable magnet support plate including a plurality of magnetic pins, the plurality of magnetic pins being capable of protruding through the plurality of holes of the heating/cooling plate and into the cavities of the microplate, the plurality of magnetic pins being adjustable height; and
a shaker to shake the microplate, the heating/cooling plate, and the magnetic support plate.

2. The integrated magnetic microbead processing apparatus of claim 1, wherein the shaker has an adjustable orbital rotation speed between 0-1200 rpm.

3. The integrated magnetic microbead processing apparatus of claim 1, wherein the height of the magnetic pins protruding above said heating plate is adjustable according to the liquid levels in the microwells.

4. The integrated magnetic microbead processing apparatus of claim 1, wherein the height of the magnetic pins protruding above the heating plate is adjustable between 1.5 mm to 4 mm.

5. The integrated magnetic microbead processing apparatus of claim 1, wherein the heating/cooling plate is configured to produce a temperature from 25° C. or room temperature up to 60° C.

6. The integrated magnetic microbead processing apparatus of claim 1, wherein the shaker has a home flag that ensures said orbital rotation stop at the same designated location.

7. The integrated magnetic bead processing apparatus of claim 1, wherein the apparatus has a microplate plastic cover and heated lip assembly to be automated with liquid handling robotic system.

8. The integrated magnetic bead processing apparatus of claim 1, wherein the microplate has flat and optically transparent bottom.

9. The integrated magnetic bead processing apparatus of claim 1, wherein said magnetic microbeads is barcoded magnetic microbeads.

10. An integrated magnetic microbeads processing method comprising:
providing a microplate having a plurality of magnetic microbeads in a plurality of microwells, the bottom of the microplate having a plurality of cavities between the microwells, a heating/cooling plate supporting the microplate, the heating/cooling plate having a plurality of holes, a vertically movable magnet support plate containing a plurality of magnetic pins, the magnetic pins being capable of protruding through the plurality of holes of the heating plate into the plurality of cavities of the microplate, the height of the magnetic pins being adjustable, and a shaker to shake the microplate, the heating/cooling plate, and the magnetic support plate, to enhance the magnetic microbeads separation;
activating the shaker to homogeneously suspend the magnetic microbeads with orbital rotation; and
then raising the magnetic pins up to increase the bead capture efficiency.

11. The integrated magnetic bead processing method of claim 10, wherein the shaker has an adjustable orbital rotation speed between 0-1200 rpm.

12. The integrated magnetic microbeads processing method of claim 10 further comprising the steps of rotating the magnetic microbeads while the magnetic pins are down, and attracting the magnetic microbeads towards the magnetic pins while the magnetic pins are up.
